(19) United States
(12) Patent Application Publication
(10) Pub. No.: US 2019/0042134 A1
(43) Pub. Date: Feb. 7, 2019

(54) STORAGE CONTROL APPARATUS AND DEDUPLICATION METHOD

(71) Applicant: FUJITSU LIMITED, Kawasaki-shi (JP)

(72) Inventors: Shinichi Nishizono, Kawasaki (JP); Akihito Kobayashi, Kawasaki (JP)

(73) Assignee: FUJITSU LIMITED, Kawasaki-shi (JP)

(21) Appl. No.: 16/036,080

(22) Filed: Jul. 16, 2018

(30) Foreign Application Priority Data
Aug. 4, 2017 (JP) 2017-151180

(51) Int. Cl. G06F 3/06; G06F 12/0866; G06F 12/0864

(52) U.S. Cl. CPC G06F 3/0641; G06F 12/0866; G06F 3/0685; G06F 3/0608; G06F 12/0864

(57) ABSTRACT

Provided is a storage control apparatus including: a cache memory configured to include a first cache area that holds a hash value of a first data block written in a physical storage area and a second cache area that holds a hash value of a second data block read from the physical storage area; and a control unit configured to execute a process including: determining, when receiving a request for writing a third data block in the physical storage area, whether the first cache area or the second cache area holds a hash value of the third data block, and performing, when the first cache area or the second cache area holds the hash value of the third data block, deduplication to avoid writing the third data block.

### CROSS-REFERENCE TO RELATED APPLICATION

This application is based upon and claims the benefit of priority of the prior Japanese Patent Application No. 2017-151180, filed on Aug. 4, 2017, the entire contents of which are incorporated herein by reference.

### FIELD

The embodiments discussed herein relate to a storage control apparatus and a deduplication method.

### BACKGROUND

In a storage system, a technique called deduplication may be applied to reduce the amount of data stored in a storage device such as a hard disk drive (HDDs) and solid state drives (SSD). The deduplication is a technique to avoid writing duplicate data by detecting whether data (write data) to be written in a storage device matches any data (existing data) already stored in the storage device.

There has been proposed a method for detecting duplicate data, for example, by comparing the hash value of write data with the hash values of the existing data and determining whether there is any existing data having the hash value of the write data. There has also been proposed a method for further comparing data having the same hash value with each other.

See, for example, Japanese Laid-open Patent Publication No. 2009-251725 and Japanese Laid-open Patent Publication No. 2014-137814.

By using the hash values as described above, whether the same data exists is quickly detected. The hash values of existing data are stored, for example, in a cache memory in a storage control apparatus that controls processing such as the deduplication in a storage system. However, since the cache memory has a limited capacity, all the hash values of the existing data could not be stored in the cache memory. Thus, when the cache memory has an insufficient free space, for example, the oldest hash value of all the hash values in the cache memory is removed to create a sufficient free space in the cache memory.

When a hash value is removed from the cache memory, the deduplication is not performed on write data having the same hash value as the removed hash value. As a result, the write data, which is the same as existing data, is written in a storage device.

For example, when a large amount of existing data stored in a single area in a storage device is copied to a different area, the storage control apparatus writes the existing data read from the single area to the different area. The hash values of the write data on which the deduplication is not performed are sequentially stored in the cache memory. If the free space in the cache memory becomes insufficient, a hash value is removed from the cache memory. Since write data having the same hash value as the removed hash value does not find a match in hash value, the deduplication is not performed on the write data.

When copy processing is performed, although the write data matches existing data, because hash value mismatch occurs due to insufficient space of the cache memory, as described above, the write data that matches existing data is written in a storage device. Namely, insufficient free space in the cache memory prevents the deduplication on some write data. Consequently, the efficiency of the deduplication deteriorates.

As in copy processing, in a situation where reading and writing are performed consecutively, there is a high chance that write data matches existing data. In this case, by modifying the control processing on the storage of hash values in a cache memory, the above deterioration of the efficiency could be reduced.

### SUMMARY

According to one aspect, there is provided a storage control apparatus including: a memory configured to include a first memory area that holds a hash value of a first data block written in a physical storage area and a second memory area that holds a hash value of a second data block read from the physical storage area; and a processor configured to execute a process including: determining, when receiving a write request for writing a third data block in the physical storage area, whether the first memory area or the second memory area holds a hash value of the third data block, and performing, when the first memory area or the second memory area holds the hash value of the third data block, deduplication to avoid writing the third data block.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a storage system according to a first embodiment;

FIG. 2 illustrates an example of a storage system according to a second embodiment;

FIG. 3 is a first diagram illustrating write control and deduplication;

FIG. 4 is a second diagram illustrating the write control and the deduplication;

FIG. 5 illustrates a structure of a write hash cache area (WHC);

FIG. 6 illustrates read control;

FIG. 7 is a first diagram illustrating the deduplication in data copy processing;

FIG. 8 is a second diagram illustrating the deduplication in data copy processing;

FIG. 9 illustrates an example of control information;

FIG. 10 is a flowchart illustrating WRITE processing; and

FIG. 11 is a flowchart illustrating READ processing.

### DESCRIPTION OF EMBODIMENTS

Embodiments will be described below with reference to the accompanying drawings. In the present description and drawings, elements having substantially the same function will be denoted by the same reference characters, and redundant description thereof will be omitted as needed.

### 1. First Embodiment

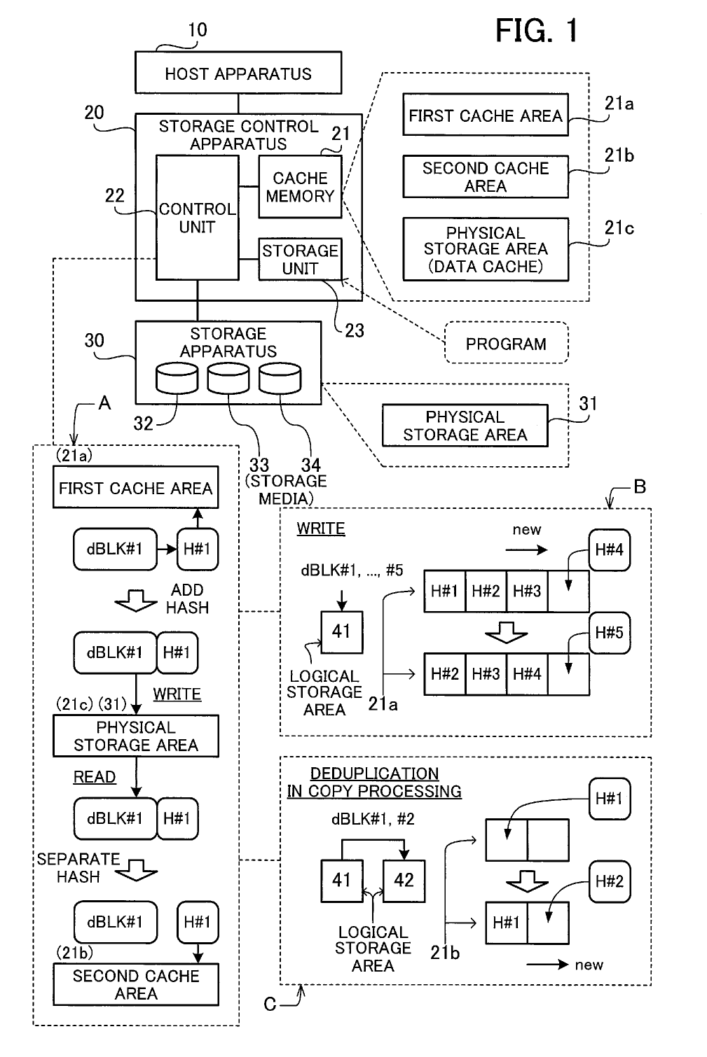

A first embodiment will be described with reference to FIG. 1. The first embodiment relates to cache control applicable to a storage system that performs deduplication. FIG. 1 illustrates an example of a storage system according to the first embodiment.

As illustrated in FIG. 1, the storage system according to the first embodiment includes a host apparatus 10, a storage control apparatus 20, and a storage apparatus 30.

For example, the host apparatus 10 is a computer such as a personal computer (PC) or a server apparatus. The host apparatus 10 is connected to the storage control apparatus 20 via a communication line such as Fibre Channel (FC) or a local area network (LAN). In addition, the host apparatus 10 accesses the storage apparatus 30 via the storage control apparatus 20.

The storage control apparatus 20 and the storage apparatus 30 function as a storage apparatus for storing data. The storage control apparatus 20 and the storage apparatus 30 are connected to each other, for example, via an interface such as Serial Attached Small Computer System Interface (SAS) or Serial Advanced Technology Attachment (SATA).

The storage control apparatus 20 controls reading and writing of data on the storage apparatus 30. A controller module (CM) that controls an operation of the storage apparatus is an example of the storage control apparatus 20. The storage control apparatus 20 includes a cache memory 21, a control unit 22, and a storage unit 23.

For example, the cache memory 21 is a memory such as a random access memory (RAM). The cache memory 21 includes a first cache area 21a, a second cache area 21b, and a physical storage area 21c. The first cache area 21a and the second cache area 21b are used to store the hash values described below. The physical storage area 21c is used as a data cache for temporarily holding data to be written (WRITE data).

Each of the first cache area 21a, the second cache area 21b, and the physical storage area 21c may be provided in a different memory. The size of the second cache area 21b may be set smaller than that of the first cache area 21a.

For example, the control unit 22 is a processor such as a central processing unit (CPU), a digital signal processor (DSP), an application specific integrated circuit (ASIC), or a field programmable gate array (FPGA).

For example, the storage unit 23 is a memory such as a RAM, an HDD, or an SSD. For example, the storage unit 23 holds a program executed by the control unit 22. The storage apparatus 30 includes storage media 32 to 34 in which data is stored. An apparatus based on technology called Redundant Arrays of Inexpensive Disks (RAID) is an example of the storage apparatus 30. For example, the storage media 32 to 34 are HDDs, SSDs, or the like.

The storage media 32 to 34 form a physical storage area 31. For example, a storage pool that virtually operates storage areas in a plurality of storage media as a single storage area or a physical volume is an example of the physical storage area 31.

The storage control apparatus 20 performs deduplication when the control unit 22 executes a program. The deduplication is processing performed when at least one of the physical storage areas 21c and 31 holds the same data as WRITE data. In the deduplication, the write destination address of the WRITE data is associated with the corresponding data (existing data) already been stored, and write processing is avoided. Since this processing suppresses writing of duplicate data, this processing contributes to saving of the storage capacity.

The above deduplication is performed for each data block having a predetermined size (for example, 4 KB), to improve the rate of the deduplication. The control unit 22 divides WRITE data into a plurality of data blocks and compares each of the data blocks of the WRITE data with the data blocks of the existing data. In this operation, the control unit 22 compares the contents of the data blocks by using the hash values of the data blocks.

For example, when the control unit 22 writes data blocks dBLK#1 to dBLK#5 in the physical storage area 21c, the control unit 22 calculates hash values H#1 to H#5 of the data blocks dBLK#1 to dBLK#5 by using a predetermined hash function. For example, when receiving 4-KB data input, the control unit 22 uses a hash function that outputs 20-byte hash values on the basis of the data contents of the data input, to calculate the hash values H#1 to H#5.

When writing the data block dBLK#1, the control unit 22 compares the hash value H#1 calculated from the data block dBLK#1 with the hash values stored in the first cache area 21a. In this example, since the hash value H#1 is not stored in the first cache area 21a, the control unit 22 adds the hash value H#1 to the data block dBLK#1 and stores the resultant data in the physical storage area 21c, as illustrated in A of FIG. 1.

The control unit 22 performs the same processing on the data blocks dBLK#2 to dBLK#5 as it does on the data block dBLK#1. In addition, after compressing the data blocks dBLK#1 to dBLK#5, the control unit 22 stores the compressed data blocks dBLK#1 to dBLK#5 in the physical storage area 21c.

Asynchronously with the write processing of the data blocks dBLK#1 to dBLK#5, the control unit 22 moves at least part of the data stored in the physical storage area 21c to the physical storage area 31 in the storage apparatus 30 and performs processing (write processing) for removing the data already been stored in the physical storage area 31 from the physical storage area 21c. The control unit 22 performs the write processing, depending on the free space or the utilization rate of the physical storage area 21c, for example, when the physical storage area 21c overflows.

When the control unit 22 receives a request for reading data to be read (READ data) corresponding to the data blocks dBLK#1 to dBLK#5 from the host apparatus 10, the control unit 22 reads the data blocks dBLK#1 to dBLK#5 from the physical storage area 21c or 31.

For example, when the data blocks dBLK#1 to dBLK#5 are stored in the physical storage area 31, the control unit 22 temporarily stores the data blocks dBLK#1 to dBLK#5 read from the physical storage area 31 in the physical storage area 21c. Next, the control unit 22 combines the data blocks dBLK#1 to dBLK#5, generates the READ data, and transmits the READ data to the host apparatus 10 as a response to the read request.

When reading the data block dBLK#1, the control unit 22 separates the hash value H#1 from the data block dBLK#1 and stores the hash value H#1 in the second cache area 21b. When reading the data blocks dBLK#2 to dBLK#5, the control unit 22 also stores the hash values H#2 to H#5 in the second cache area 21b.

As described above, the first cache area 21a and the second cache area 21b are used to store hash values. When the hash values of the data blocks dBLK#1 to dBLK#5 are not stored in the first cache area 21a, the data blocks dBLK#1 to dBLK#5 are written in the physical storage area 21c in accordance with the above flow. In contrast, if the hash value of a data block dBLK#k (k=any one of 1 to 5) is stored in the first cache area 21a, the deduplication is performed on the data block dBLK#k.

First, a situation in which the data blocks dBLK#1 to dBLK#5 are written in a logical storage area 41 when the first cache area 21a having a size capable of holding four data blocks is empty will be described. For example, the logical storage area 41 is associated with a certain area in the physical storage area 21c. In this case, as described above, the control unit 22 calculates the hash values H#1 to H#5 of the data blocks dBLK#1 to dBLK#5 and sequentially stores the hash values H#1 to H#5 in the first cache area 21a.

In this example, when the control unit 22 has stored the hash values H#1 to H#4 in the first cache area 21a, the first cache area 21a becomes full. Thus, as illustrated in B of FIG. 1, the control unit 22 removes the hash value H#1, which is the oldest hash value in the first cache area 21a, to create free space. Next, the control unit 22 stores the hash value H#5 in the first cache area 21a. In addition, the control unit 22 adds the hash values H#1 to H#5 to the data blocks dBLK#1 to dBLK#5 and stores the data of the data blocks dBLK#1 to dBLK#5 in the area in the physical storage area 21c, the area corresponding to the logical storage area 41.

In the above state, as illustrated in C of FIG. 1, when the control unit 22 copies the data blocks dBLK#1 and dBLK#2 in the logical storage area 41 to a logical storage area 42, the control unit 22 sequentially reads the data blocks dBLK#1 and dBLK#2 from the physical storage area 21c. In addition, the control unit 22 sequentially stores the hash values H#1 and H#2 added to the data blocks dBLK#1 and dBLK#2 in the second cache area 21b.

In addition, before the control unit 22 stores the read data block dBLK#1 in the area in the physical storage area 21c, the area corresponding to the logical storage area 42, the control unit 22 determines whether the deduplication is executable on the data block dBLK#1. In this operation, the control unit 22 searches the first cache area 21a and the second cache area 21b for the hash value H#1.

As illustrated in B of FIG. 1, the hash value H#1 has already been removed from the first cache area 21a. Thus, the hash value H#1 is not detected in the first cache area 21a (a cache MISS). However, the hash value H#1 has been stored in the second cache area 21b when reading of the data block dBLK#1 has been performed. Thus, the hash value H#1 is detected in the second cache area 21b (a cache HIT).

Since the hash value H#1 is detected in the second cache area 21b, the control unit 22 determines that the deduplication of the data block dBLK#1 is possible. In this case, the control unit 22 associates the area in the physical storage area 21c, the area corresponding to the logical storage area 41, with the logical storage area 42 and avoids storing the data block dBLK#1 in the physical storage area 21c (execution of the deduplication). Likewise, the deduplication is performed on the data block dBLK#2.

As described above, when the control unit 22 receives a request for writing a data block in the physical storage area 21c, the control unit 22 determines whether the hash value of the data block is stored in the first cache area 21a or the second cache area 21b. If the same hash value is stored, the control unit 22 performs the deduplication on the data block.

Copy processing is performed on a premise that the data to be copied is stored in the physical storage area 21c or 31. Thus, when reading data, the control unit 22 stores the corresponding hash value in the second cache area 21b. Next, when writing the data, the control unit 22 refers to the second cache area 21b. In this way, even when the control unit 22 searches the first cache area 21a and a cache MISS occurs, the deduplication is performed.

For convenience of the description, a case in which copy processing is performed has been described. However, even when processing other than copy processing is performed, arranging the second cache area 21b could contribute to improvement of the rate of the deduplication. For example, when data is partially rewritten, there are cases in which the data is read from the physical storage area 21c or 31, the read data is updated, and the original data and the updated data are written in different areas. If only some of the original data is updated, many of the data blocks remain the same. In this case, the cache MISS reduction effect is also achieved.

The first embodiment has thus been described. As described above, the control unit 22 stores a hash value at the time of reading and performs deduplication by referring to a hash value stored at the time of writing and also the hash value stored at the time of reading. In this way, the efficiency of the deduplication is improved.

### 2. Second Embodiment

Next, a second embodiment will be described. The second embodiment relates to cache control applicable to a storage system that performs deduplication.

[2-1. Storage System]

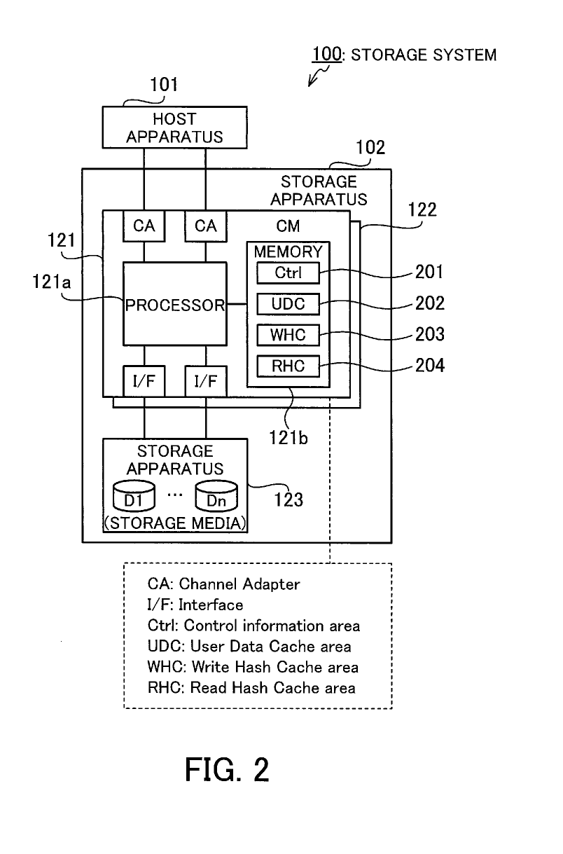

A storage system 100 will be described with reference to FIG. 2. FIG. 2 illustrate an example of a storage system according to the second embodiment. The storage system 100 illustrated in FIG. 2 is an example of the storage system according to the second embodiment.

As illustrated in FIG. 2, the storage system 100 includes a host apparatus 101 and a storage apparatus 102. The storage apparatus 102 includes CMs 121 and 122 and a storage apparatus 123.

While FIG. 2 illustrates an example in which the storage apparatus 102 includes two CMs, the technique according to the second embodiment is also applicable to a case in which the storage apparatus 102 includes one CM or three or more CMs. In addition, the following description assumes that the CMs 121 and 122 have substantially the same hardware and functions, and detailed description of the CM 122 will be omitted as needed.

The CM 121 includes a plurality of channel adapters (CAs), a plurality of interfaces (I/Fs), a processor 121a, and a memory 121b.

An individual CA is an adapter circuit that controls connection with the host apparatus 101. For example, a CA is connected to a host bus adapter (HBA) provided in the host apparatus 101 or a switch arranged between the CA and the host apparatus 101 via a communication line such as FC. An individual I/F is an interface for connecting a corresponding CM to the storage apparatus 123 via a line such as SAS or SATA.

For example, the processor 121a is a CPU, a DSP, an ASIC, an FPGA, or the like. For example, the memory 121b is a RAM, a flash memory, or the like. In this connection, FIG. 2 illustrates an example where the memory 121b is provided in the CM 121, but a memory provided and connected outside the CM 121 may be used.

The memory 121b includes a control information area (Ctrl) 201 holding the control information described below and a user data cache area (UDC) 202 temporarily holding user data. The memory 121b also includes a write hash cache area (WHC) 203 holding hash values of WRITE data and a read hash cache area (RHC) 204 holding hash values of READ data.

The UDC 202 is an example of a physical storage area. In addition, at least a part of the UDC 202, the WHC 203, and the RHC 204 may be provided in a memory connected outside the CM 121. Each of the UDC 202, the WHC 203, and the RHC 204 may be set in a different memory.

The storage apparatus 123 includes storage media D1 to Dn. The storage media D1 to Dn are, for example, SSDs, HDDs, or the like. Different kinds of storage media (HDDs, SSDs, etc.) may be used as the storage media D1 to Dn. The number n of storage media included in the storage apparatus 123 is any number of 1 or more. For example, a disk array (a storage array) or a RAID apparatus is an example of the storage apparatus 123. The storage apparatus 123 is an example of a physical storage area.

The CM 122 includes the same elements as those of the above CM 121. In addition, the CMs 121 and 122 are connected inside the storage apparatus 102 and communicate with each other. The CM 122 also accesses the storage apparatus 123, as is the case with the CM 121.

The storage system 100 has thus been described. Hereinafter, cache control according to the second embodiment will be described by using the storage system 100 illustrated in FIG. 2 as an example.

[2-2. Cache Control and Deduplication]

The cache control and deduplication according to the second embodiment are performed mainly by the processor 121a.

When writing user data in the UDC 202, the processor 121a stores the hash values of the user data in the WHC 203. In addition, when reading user data from the UDC 202, the processor 121a stores the hash values of the user data in the RHC 204. Before performing the deduplication, the processor 121a determines whether to perform the deduplication by referring to the hash values stored in the WHC 203 and the RHC 204.

When only the WHC 203 is used, if the WHC 203 overflows, even if the same user data is stored in the UDC 202, the deduplication is not performed. Thus, user data (duplicate data) whose content has already been stored could be written in the UDC 202. As a result, the ratio of the duplicate data (duplication ratio) could increase. In other words, the rate of the deduplication could deteriorate. However, by using both the WHC 203 and the RHC 204, it is possible to reduce the risk of deterioration of the rate of the deduplication due to the overflow of the WHC 203.

By increasing the size of the WHC 203, the chance of the occurrence of a cache MISS is reduced. If the ratio of duplicate data to the user data (WRITE data) to be written (duplication ratio) is large, the risk of the overflow of the WHC 203 is decreased. However, ensuring the WHC 203 having a large capacity needs an unrealistic cost. In addition, it is difficult to cause the storage apparatus 102 to control the duplication ratio of the WRITE data. Thus, it is beneficial to suppress the risk of the deterioration of the rate of the deduplication by arranging the RHC 204.

Hereinafter, the above cache control and deduplication will be described further.

(Write Control and Deduplication)

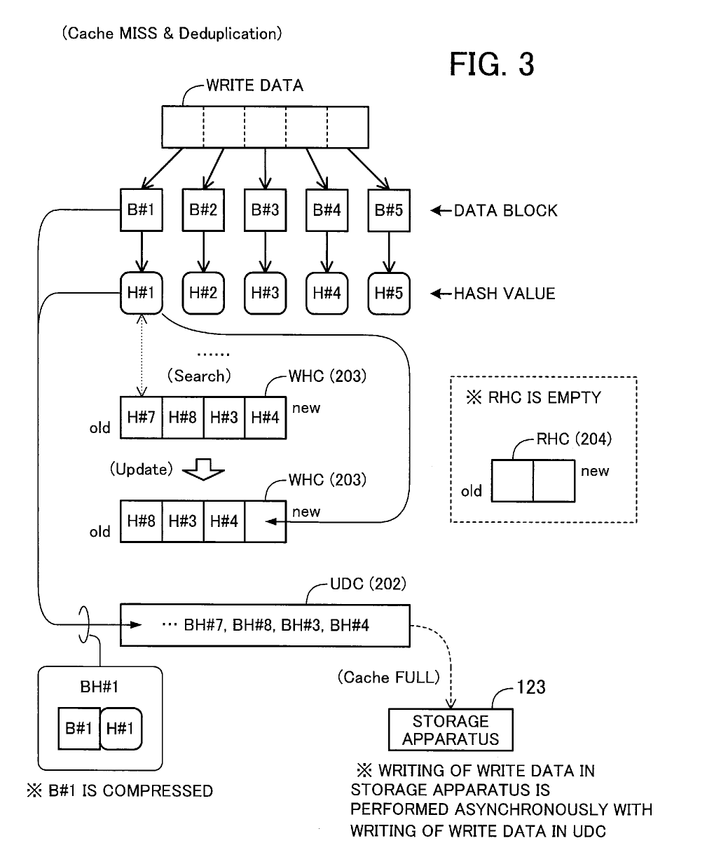

When receiving a request for writing WRITE data from the host apparatus 101, for example, the processor 121a performs write control and deduplication in accordance with a method as illustrated in FIG. 3. FIG. 3 is a first diagram illustrating write control and deduplication.

When receiving a write request, the processor 121a divides the WRITE data into data blocks each having a predetermined size (for example, 4 KB). In the example in FIG. 3, the WRITE data has been divided into five data blocks B#1 to B#5. The processor 121a calculates hash values H#1 to H#5 of the data blocks B#1 to B#5 and sequentially compares the hash values H#1 to H#5 with the hash values in the WHC 203.

In the example in FIG. 3, hash values H#7, H#8, H#3, and H#4 are stored in the WHC 203 from least recently used (hereinafter, referred to as “oldest”) to most recently used. For example, the processor 121a compares the hash value H#1 with each of the hash values H#7, H#8, H#3, and H#4 in the WHC 203 (Search). In this example, the hash value H#1 is not stored in the WHC 203. In this case, the processor 121a compares the hash value H#1 with the hash values in the RHC 204.

In the example in FIG. 3, no hash value is stored in the RHC 204. Thus, the processor 121a determines that the hash value H#1 is stored neither in the WHC 203 nor the RHC 204 (cache MISS). In this case, the processor 121a does not perform the deduplication on the data block B#1 but stores the hash value H#1 in the WHC 203.

However, since the hash values H#7, H#8, H#3, and H#4 are already stored in the WHC 203, there is no free space for storing the hash value H#1. In this case, the processor 121a removes the hash value H#7, which is the oldest hash value in the WHC 203, and creates a free space in the WHC 203. Next, the processor 121a stores the hash value H#1 in the created free space in the WHC 203. In this way, when the WHC 203 overflows, at least one hash value is removed in order from the oldest, and the WHC 203 is updated (Update).

In addition, the processor 121a compresses the data block B#1, on which the deduplication has not been performed, and adds the hash value H#1 to the compressed data block B#1, to generate compressed data BH#1. Next, the processor 121a stores the compressed data BH#1 in the UDC 202. When the UDC 202 overflows (for example, when the free space in the UDC 202 indicates a reference value or less or when the utilization indicates a threshold or more), the processor 121a writes the compressed data stored in the UDC 202 to the storage apparatus 123, asynchronously with the writing of the WRITE data.

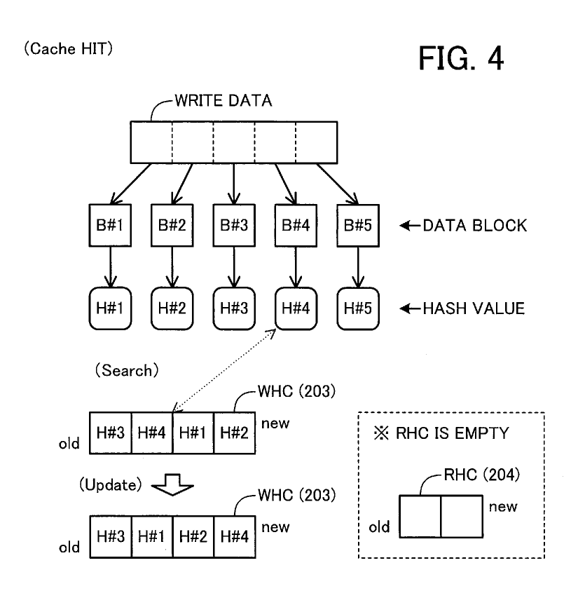

As described above, when a cache MISS occurs, the processing as illustrated in FIG. 3 is performed. On the other hand, when the WHC 203 or the RHC 204 holds the comparison target hash value (a cache HIT), the processing as illustrated in FIG. 4 is performed. FIG. 4 is a second diagram illustrating the write control and the deduplication.

In the example in FIG. 4, the hash values H#3, H#4, H#1, and H#2 are stored in the WHC 203 in order from the oldest. For example, the processor 121a compares the hash value H#4 with each of the hash values H#3, H#4, H#1, and H#2 in the WHC 203 (Search). In this example, the hash value H#4 is stored in the WHC 203. Thus, the processor 121a performs the deduplication on the data block B#4.

In addition, the processor 121a moves the hash value H#4 to the latest location in the WHC 203. In this way, when the WHC 203 does not overflow, the processor 121a moves the hash value and updates the WHC 203 (Update). Since the deduplication is performed on the data block B#4, the data block B#4 and the hash value H#4 are not written in the UDC 202. In addition, the processor 121a associates a location of the data block B#4 (the address of the compressed data BH#4) in the UDC 202 or the storage apparatus 123 with a write destination and transmits a response indicating completion of the writing to the host apparatus 101.

By executing a program, the processor 121a performs the write control and deduplication in accordance with the above method.

(Structure of WHC)

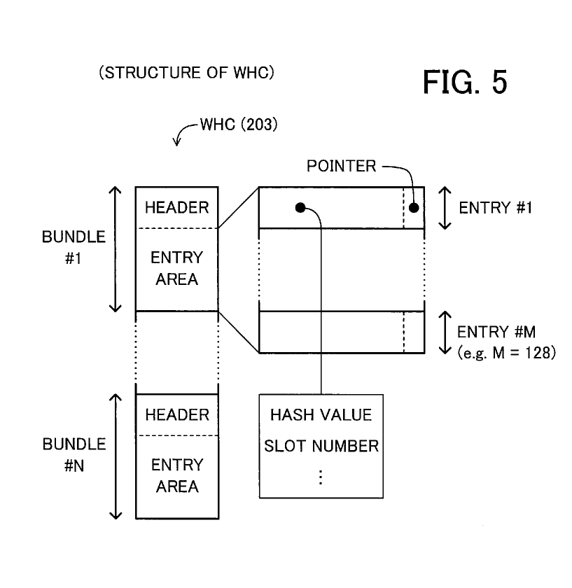

Next, a structure of the WHC 203 will be described with reference to FIG. 5. FIG. 5 illustrates a structure of the WHC. The structure of the WHC 203 illustrated in FIG. 5 is an example and may be changed. The RHC 204 may be configured to have the same structure as that of the WHC 203.

As illustrated in FIG. 5, in the WHC 203, a hash value corresponding to a single data block is managed per entry. A group of M (for example, M=128) entries may be called a bundle. An individual bundle includes a header including bundle identification information or the like and an entry area in which M entries may be registered. An individual entry includes a hash value, a slot number to be described below, and a pointer indicating an entry location.

The processor 121a manages the old and new statuses of entries in each bundle. When an entry area overflows, the processor 121a removes the oldest entry and holds a new entry. For example, the bundle in which a hash value is stored may be determined on the basis of a value obtained by dividing the hash value by the total number of bundles. In accordance with this method, when performing the searching, the processor 121a is able to determine a storage destination from a hash value by using the known total number of bundles.

(Read Control)

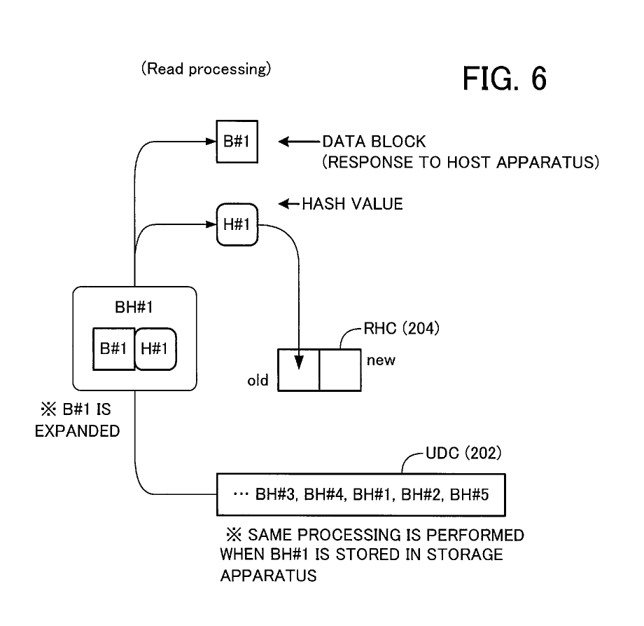

Next, read control will be described with reference to FIG. 6. FIG. 6 illustrates read control.

For example, when reading the data block B#1 from the UDC 202, the processor 121a performs processing as illustrated in FIG. 6. When the compressed data BH#1 corresponding to the data block B#1 is stored only in the storage apparatus 123, the processor 121a reads the compressed data BH#1 from the storage apparatus 123 and stores the compressed data BH#1 in the UDC 202.

The processor 121a reads the compressed data BH#1 from the UDC 202 and expands the compressed data block B#1, to restore the original data block B#1. In addition, the processor 121a acquires the hash value H#1 included in the compressed data BH#1 and stores the hash value H#1 in the RHC 204. Next, the processor 121a transmits the data block B#1 to the host apparatus 101 as a response to the read request.

In the example in FIG. 6, the RHC 204 has a free space and is able to hold the hash value H#1. If the RHC 204 overflows, as is the case with the WHC 203, the hash value H#1 is stored in the free space created by removing the oldest hash value. The read processing is performed as described above.

(Deduplication in Data Copy Processing)

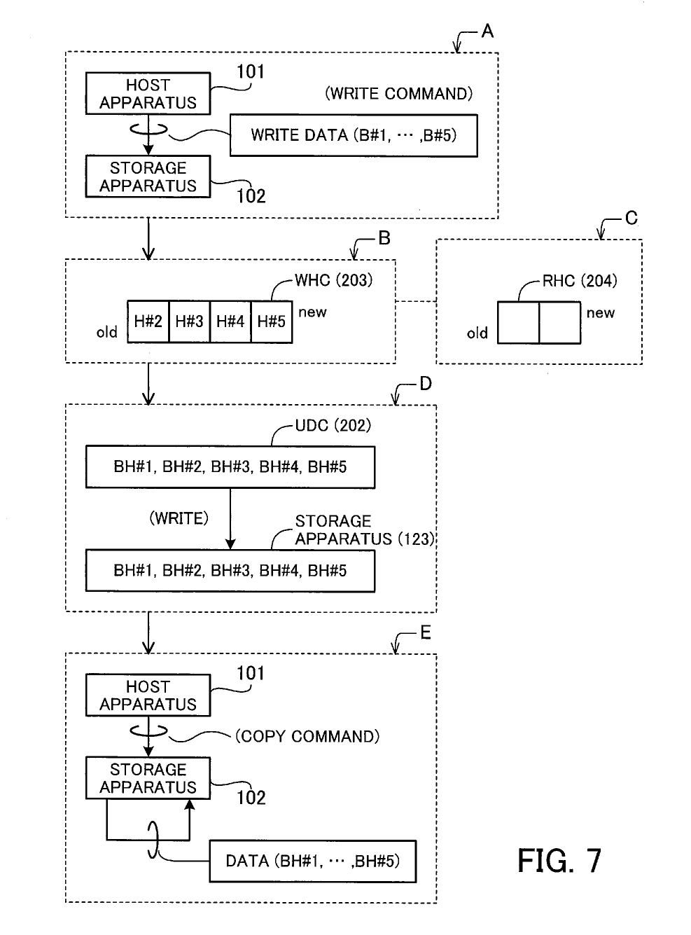

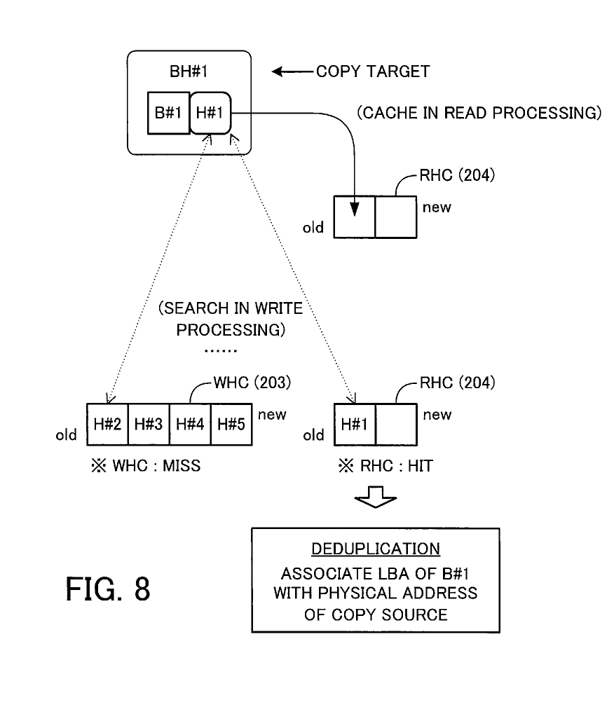

Next, the deduplication in data copy processing will be described with reference to FIGS. 7 and 8. FIGS. 7 and 8 are first and second diagrams, respectively, illustrating deduplication in data copy processing.

As illustrated in A of FIG. 7, the following description assumes that WRITE data including the data blocks B#1 to B#5 has already been written from the host apparatus 101 in the storage apparatus 102 in response to a WRITE command. When the WHC 203 is empty and the data blocks B#1 to B#5 are written in the UDC 202, as illustrated in B of FIG. 7, the hash values H#2 to H#5 are stored in the WHC 203 in order from the oldest. The following description assumes that the RHC 204 is empty as illustrated in C of FIG. 7.

As described above, when writing the data blocks B#1 to B#5 in the UDC 202, the processor 121a compresses the data blocks B#1 to B#5 and generates compressed data BH#1 to BH#5 to which the hash values H#1 to H#5 have been added. Next, the processor 121a stores the compressed data BH#1 to BH#5 in the UDC 202.

If a predetermined condition such as the free space in or the utilization of the UDC 202 is met, the processor 121a writes the compressed data BH#1 to BH#5 stored in the UDC 202 to the storage apparatus 123, asynchronously with the processing based on the WRITE command, as illustrated in D of FIG. 7. After this writing, if the UDC 202 has a free space, the processor 121a allows the compressed data BH#1 to BH#5 to remain in the UDC 202. Otherwise, the processor 121a removes the compressed data BH#1 to BH#5 from the UDC 202.

After the above processing is completed, as illustrated in E of FIG. 7, if the storage apparatus 102 receives a command for copying the above WRITE data from the host apparatus 101, the processor 121a copies the compressed data BH#1 to BH#5. In this operation, the processor 121a performs the cache control and deduplication in accordance with the method as illustrated in FIG. 8.

The processor 121a reads the compressed data BH#1 including the copy target data block B#1 from the storage apparatus 123 and stores the compressed data BH#1 in the UDC 202. In addition, as illustrated in FIG. 8, the processor 121a acquires the hash value H#1 from the compressed data BH#1 and stores the acquired hash value H#1 in the RHC 204.

Next, the processor 121a searches the WHC 203 for the hash value H#1 (Search in write processing). As illustrated in B of FIG. 7, the WHC 203 does not hold the hash value H#1. Thus, the searching of the WHC 203 results in a cache MISS. In this case, the processor 121a searches the RHC 204 for the hash value H#1 (Search in write processing). As described above, the RHC 204 holds the hash value H#1 acquired from the compressed data BH#1 (a cache HIT).

Since the searching of the RHC 204 results in a cache HIT, the processor 121a performs the deduplication on the data block B#1. For example, the processor 121a associates a logical address (Logical Block Addressing: LBA) to which the data block B#1 is copied with a physical address of the compressed data BH#1. In this case, the processor 121a avoids storing the compressed data BH#1 in the UDC 202. In addition, the processor 121a notifies the host apparatus 101 of completion of the copying of the data block B#1.

As in data copy processing, when an existing data block is read and written in a different logical address, a duplicate data block certainly exists. Thus, a deduplication miss is prevented by storing the corresponding hash value in the RHC 204 when reading the existing data block and by referring to the hash value when writing the data block.

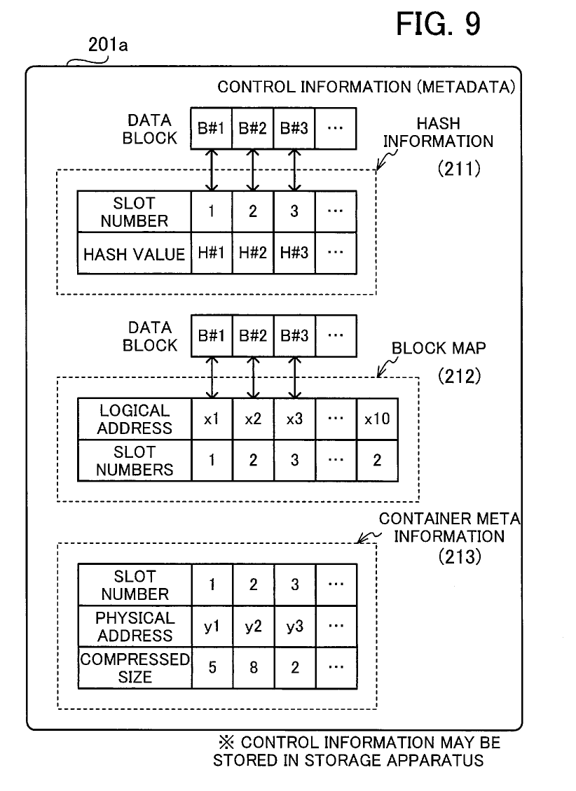

Hereinafter, control information 201a stored in the control information area 201 will be described with reference to FIG. 9. FIG. 9 illustrates an example of control information.

As illustrated in FIG. 9, the control information 201a includes hash information 211, a block map 212, and container meta information 213.

As described above, the storage apparatus 102 divides user data into data blocks each having a predetermined size and manages the user data per data block. An individual data block storage destination is managed by using a slot number. For example, the storage destinations of the data blocks B#1 to B#3 are associated with slot numbers 1 to 3, respectively.

In the hash information 211, an individual hash value is associated with a slot number. For example, the slot numbers 1 to 3 are associated with the hash values H#1 to H#3, respectively, in the hash information 211. Since a data block and a hash value match on a one-to-one basis, a slot number and a data block are associated with each other in the hash information 211.

In the block map 212, a logical address indicating a storage location of a data block is associated with a slot number corresponding to the data block. An individual logical address is, for example, an address indicating a location in a logical storage area expressed by a logical volume, a virtual disk, a logical unit number (LUN), or the like. In the case of a data block on which the deduplication is performed, a single slot number is associated with a plurality of logical addresses.

As described above, since an individual slot number matches a data block, a corresponding data block is associated with a corresponding logical address via the block map 212. When the deduplication has been performed, since the same data block is referred to from a plurality of logical addresses, as described above, the same slot number is associated with the plurality of logical addresses. In the example in FIG. 9, logical addresses x2 and x10 are associated with the slot number 2.

In the container meta information 213, an individual slot number is associated with a physical address indicating a storage location of a data block corresponding to the slot number. The container meta information 213 may include a compressed size of a data block. An individual physical address is an address indicating a location in a physical storage area provided by the UDC 202 or the storage apparatus 123. The correspondence relationship between the logical address and the physical address of an individual data block is determined from the block map 212 and the container meta information 213.

The control information 201a may be referred to as metadata. In addition, at least part of the control information 201a may be stored in the storage apparatus 123.

The cache control and deduplication according to the second embodiment have thus been described.

[2-3. Processing]

Next, processing performed by the storage apparatus 102 will be described.

(WRITE Processing)

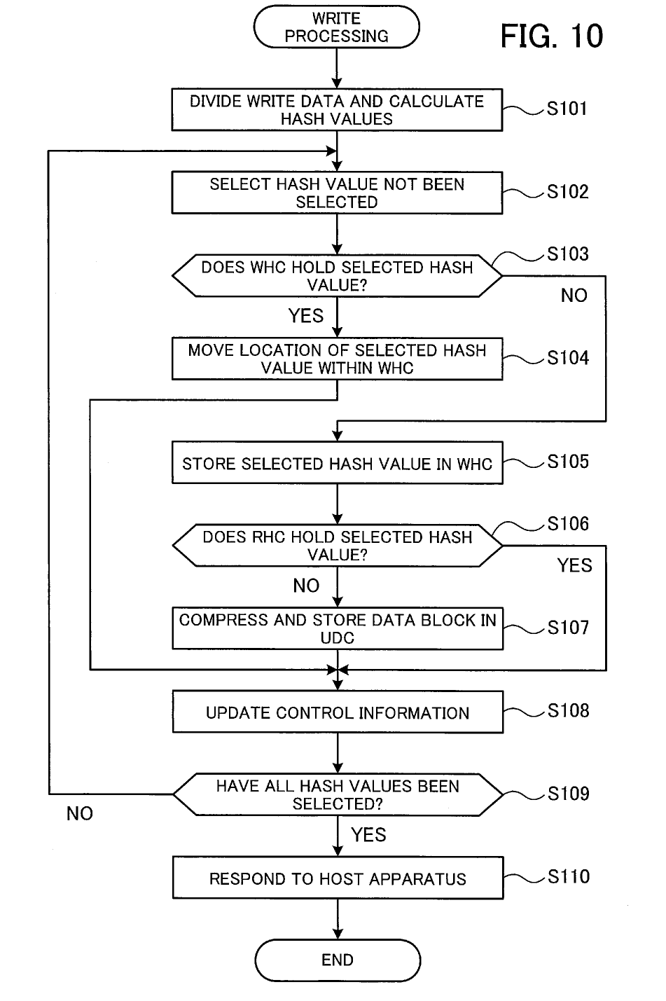

First, WRITE processing will be described with reference to FIG. 10. FIG. 10 is a flowchart illustrating WRITE processing.

(S101) When the processor 121a receives a request for writing WRITE data from the host apparatus 101, the processor 121a divides the WRITE data into a plurality of data blocks. In addition, the processor 121a calculates the hash values of the data blocks.

(S102) The processor 121a selects one of the hash values calculated in S101 that has not been selected yet. This hash value selected in S102 will be referred to as a selected hash value, as needed.

(S103) The processor 121a determines whether the WHC 203 holds the selected hash value. If the WHC 203 holds the selected hash value, the processing proceeds to S104. If the WHC 203 does not hold the selected hash value, the processing proceeds to S105.

(S104) The processor 121a moves the location of the selected hash value to the latest location in the WHC 203 (see FIG. 4). After S104, the processing proceeds to S108.

(S105) The processor 121a stores the selected hash value in the WHC 203. If the WHC 203 does not have a free space, the processor 121a creates a free space by removing the oldest hash value in the WHC 203. Next, the processor 121a stores the selected hash value in the WHC 203 (see FIG. 3).

(S106) The processor 121a determines whether the RHC 204 holds the selected hash value. If the RHC 204 holds the selected hash value, the processing proceeds to S108. If the RHC 204 does not hold the hash value, the processing proceeds to S107.

(S107) The processor 121a compresses the data block corresponding to the selected hash value. In addition, the processor 121a adds the selected hash value to the compressed data block to generate compressed data and stores the compressed data in the UDC 202.

(S108) The processor 121a updates the control information 201a.

(Updated content #1) If the WHC 203 holds the selected hash value (S103: YES), the processor 121a refers to the hash information 211 and determines the slot number corresponding to the selected hash value. In addition, the processor 121a registers a logical address, which is the write destination of the selected hash value, in the block map 212 and associates the registered logical address with the determined slot number. In this way, the deduplication is performed on the data block corresponding to the selected hash value.

(Updated content #2) If the RHC 204 holds the selected hash value (S106: YES), the processor 121a refers to the hash information 211 and determines the slot number corresponding to the selected hash value. In addition, the processor 121a registers a logical address, which is the write destination of the selected hash value, in the block map 212 and associates the registered logical address with the determined slot number. In this way, the deduplication is performed on the data block corresponding to the selected hash value.

(Updated content #3) If neither the WHC 203 nor the RHC 204 holds the selected hash value (S103: NO, S106: NO), the processor 121a registers a logical address, which is the write destination of the selected hash value, in the block map 212 and associates the registered logical address with a newly created slot number. In addition, the processor 121a registers the new slot number in the hash information 211 and associates the registered slot number with the selected hash value.

In addition, the processor 121a registers the new slot number in the container meta information 213 and associates the registered slot number with a physical address, which is the storage destination of the data block corresponding to the selected hash value (an address indicating a location in the UDC 202 in this case). In addition, the processor 121a associates the slot number registered in the container meta information 213 with the compressed size of the data block.

(S109) The processor 121a determines whether all the hash values have been selected. If there is a hash value not been selected, the processing returns to S102. If all the hash values have been selected, the processing proceeds to S110.

(S110) The processor 121a transmits a message indicating that the WRITE data has been written to the host apparatus 101, as a response to the write request. After S110, the processor 121a ends the processing illustrated in FIG. 10.

(READ Processing)

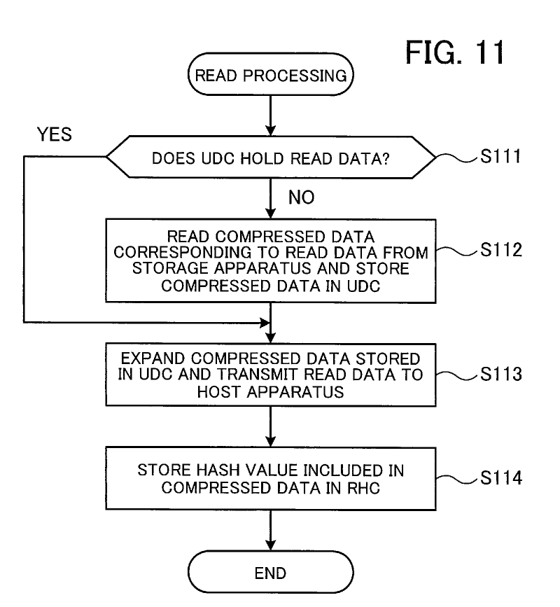

Next, READ processing will be described with reference to FIG. 11. FIG. 11 is a flowchart illustrating READ processing.

(S111) When receiving a request for reading READ data from the host apparatus 101, the processor 121a determines whether the UDC 202 holds the READ data.

For example, the processor 121a refers to the block map 212 and the container meta information 213 and determines whether the physical address corresponding to the logical address from which the READ data is read corresponds to the UDC 202 or the storage apparatus 123.

If this logical address corresponds to a physical address in the UDC 202, the processor 121a determines that the UDC 202 holds the READ data. If the logical address corresponds to a physical address in the storage apparatus 123, the processor 121a determines that the storage apparatus 123 holds the READ data.

If the UDC 202 holds the READ data, the processing proceeds to S113. If the UDC 202 does not hold the READ data (if the storage apparatus 123 holds the READ data), the processing proceeds to S112.

(S112) The processor 121a reads the READ data from the storage apparatus 123 and stores the READ data in the UDC 202. For example, the processor 121a refers to the block map 212 and the container meta information 213 and determines the physical address corresponding to the above logical address. Next, the processor 121a reads the compressed data stored at the determined physical address and stores the compressed data in the UDC 202.

(S113) The processor 121a expands the compressed data blocks included in the compressed data stored in the UDC 202 and restores the original data blocks. In addition, the processor 121a combines the plurality of data blocks restored, to restore the READ data. Next, the processor 121a transmits the restored READ data to the host apparatus 101, as a response to the read request.

(S114) The processor 121a acquires the hash values included in the compressed data and stores the acquired hash values in the RHC 204 (see FIG. 8). After S114, the processor 121a ends the processing illustrated in FIG. 11.

The processing performed by the storage apparatus 102 has thus been described. As described above, the processor 121a stores a hash value at the time of reading and performs deduplication by referring to a hash value stored at the time of writing and also the hash value stored at the time of reading. In this way, the efficiency of the deduplication is improved.

The second embodiment has thus been described.

The functions of any one of the above host apparatuses 10 and 101, the storage control apparatus 20, and the storage apparatus 102 (the CMs 121 and 122) may be realized by causing a processor included in the corresponding apparatus to execute a program.

This program may be stored in a computer-readable storage medium. Examples of the computer-readable storage medium include a magnetic storage device, an optical disc, a magneto-optical storage medium, and a semiconductor memory. Examples of the magnetic storage device include an HDD, a flexible disk (FD), and a magnetic tape. Examples of the optical disc include a digital versatile disc (DVD), a DVD-RAM, a compact disc-read only memory (CD-ROM), and a compact disc recordable/re-writable (CD-R/RW). Examples of the magneto-optical storage medium include a magneto-optical disk (MO).

One way to distribute the program is, for example, to sell portable storage media such as DVDs or CD-ROMs in which the program is recorded. In addition, the program may be stored in a storage device of a server computer and forwarded to other computers from the server computer via a network.

For example, a computer that executes the program stores the program stored in a portable storage medium or forwarded from the server computer in a storage device of the computer. Next, the computer reads the program from its storage device and executes processing in accordance with the program. The computer may directly read the program from the portable storage medium and execute processing in accordance with the program. In addition, each time the computer receives a program from the server computer connected via a network, the computer may execute processing in accordance with the program received from the server computer.

According to one aspect, the efficiently of the deduplication is improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage control apparatus comprising:
a memory configured to include a first memory area that holds a hash value of a first data block written in a physical storage area and a second memory area that holds a hash value of a second data block read from the physical storage area; and
a processor configured to execute a process including:
determining, when receiving a write request for writing a third data block in the physical storage area, whether the first memory area or the second memory area holds a hash value of the third data block, and
performing, when the first memory area or the second memory area holds the hash value of the third data block, deduplication to avoid writing the third data block.

2. The storage control apparatus according to claim 1, wherein the determining includes searching, when receiving the write request, the first memory area for the hash value of the third data block and searching, when the first memory area does not hold the hash value of the third data block, the second memory area for the hash value of the third data block.

3. The storage control apparatus according to claim 2, wherein the process further includes removing, when newly storing the hash value of the third data block causes the first memory area to overflow, a hash value in the first memory area in order from oldest.

4. The storage control apparatus according to claim 3, wherein the process further includes
writing the third data block having the hash value thereof added thereto in the physical storage area, and
acquiring the hash value added to the second data block read from the physical storage area and storing the acquired hash value in the second memory area.

5. A non-transitory computer-readable storage medium storing a computer program that causes a computer to execute a process comprising:
storing a hash value of a first data block written in a physical storage area in a first memory area and storing a hash value of a second data block read from the physical storage area in a second memory area; and
determining, when receiving a write request for writing a third data block in the physical storage area, whether the first memory area or the second memory area holds a hash value of the third data block and performing, when the first memory area or the second memory area holds the hash value of the third data block, deduplication to avoid writing the third data block.

6. A deduplication method comprising:
storing, by a computer, a hash value of a first data block written in a physical storage area in a first memory area and storing a hash value of a second data block read from the physical storage area in a second memory area; and
determining, by the computer, when receiving a write request for writing a third data block in the physical storage area, whether the first memory area or the second memory area holds a hash value of the third data block and performing, when the first memory area or the second memory area holds the hash value of the third data block, deduplication to avoid writing the third data block.

7. The non-transitory computer-readable storage medium according to claim 5, wherein the determining includes searching, when receiving the write request, the first memory area for the hash value of the third data block and searching, when the first memory area does not hold the hash value of the third data block, the second memory area for the hash value of the third data block.

8. The non-transitory computer-readable storage medium according to claim 7, wherein the process further includes removing, when newly storing the hash value of the third data block causes the first memory area to overflow, a hash value in the first memory area in order from oldest.

9. The non-transitory computer-readable storage medium according to claim 8, wherein the process further includes
writing the third data block having the hash value thereof added thereto in the physical storage area, and
acquiring the hash value added to the second data block read from the physical storage area and storing the acquired hash value in the second memory area.
